(19) United States
(12) Patent Application Publication
(10) Pub. No.: US 2019/0042888 A1
(43) Pub. Date: Feb. 7, 2019

(54) TRAINING METHOD, TRAINING APPARATUS, REGION CLASSIFIER, AND NON-TRANSITORY COMPUTER READABLE MEDIUM

(71) Applicant: Preferred Networks, Inc., Tokyo (JP)

(72) Inventors: Satoshi Tsutsui, Tokyo (JP); Tommi Kerola, Tokyo (JP)

(21) Appl. No.: 16/051,795

(22) Filed: Aug. 1, 2018

(30) Foreign Application Priority Data
Aug. 2, 2017 (JP) 2017-150006

(51) Int. Cl. G06K 9/62; G06T 7/11; G06K 9/46; G06N 3/08

(52) U.S. Cl. CPC G06K 9/6259; G06T 7/11; G06K 9/6262; G06K 9/6257; G06K 9/00791; G06K 9/6267; G06K 9/6228; G06N 3/08; G06K 9/4676

(57) ABSTRACT

A region classifier training method includes generating a first network which outputs a saliency map with respect to an input image; generating superpixels of the input image; generating a weak segmentation for extracting a target region based on the saliency map and the superpixels; and training and generating a second network being a region classifier which classifies the target region when the input image is input, by using the weak segmentation as supervised data.

### CROSS-REFERENCE TO RELATED APPLICATIONS

This application is based upon and claims the benefit of priority from Japanese Patent Application No. 2017-150006, filed on Aug. 2, 2017; the entire contents of which are incorporated herein by reference.

### FIELD

Embodiments described herein relate to a training method, a training apparatus, a region discriminator, and a non-transitory computer readable medium.

### BACKGROUND

Classifying each pixel as corresponding to a road or not is an essential task for practical autonomous driving systems. While basic research on fine-grained segmentation for autonomous driving has been explored previously, a practical driving system does not necessarily require segmentation using pixel-wise classification for most static or moving traffic objects such as vehicles, pedestrians, and traffic signs. On the other hand, the pixel-wise classification is necessary for the road itself. A car centric image always has the same perspective view, where the car body is clearly visible as a constant part of each image, different from a general road image which can be taken from various perspectives, including aerial views.

Recently work on weakly supervised segmentation employs a convolutional neural network (CNN) trained with image-level labels for the task of classification. For example, this classification utilizes a saliency map that highlights the pixels contributing to classification results. However, this approach can not directly be applied to road segmentation using car centric image, as in all images, the road is visible, which would make it impossible to train a classifier, since there are no negative samples. Even if non-road images were collected and a binary classifier was trained, the saliency map would highlight the non-road objects that always appear in the car centric image, e.g. the car body.

### BRIEF DESCRIPTION OF THE DRAWINGS

FIG. 1 is a chart of a training method according to one embodiment;

FIG. 2 are examples of road images;

FIG. 3 are examples of non-road images;

FIG. 4 are examples of graph-based superpixels;

FIG. 5 is an example of chart for generating weak segmentation mask according to one embodiment;

FIG. 6 are examples of saliency map;

FIG. 7 is mIOU of each figure illustrated in FIG. 6;

FIG. 8 is experimental results of tuning threshold parameters;

FIG. 9 are experimental results of the method according to one embodiment;

FIG. 10 is experimental results of training an FCN on generated weak labels according to one embodiment; and

FIG. 11 is a block diagram of a training apparatus according to one embodiment; and

FIG. 12 is an example of hardware implementations according to one embodiment.

### DETAILED DESCRIPTION

According to one embodiment, a region classifier training method includes generating a first network which outputs a saliency map with respect to an input image; generating superpixels of the input image; generating a weak segmentation for extracting a target region based on the saliency map and the superpixels; and training and generating a second network being a region classifier which classifies the target region when the input image is input, by using the weak segmentation as supervised data.

Hereinafter, embodiments of the present invention will be described in detail with reference to the drawings.

In the present embodiment, by using a method of distantly supervision being a method of learning saliency by making use of existing image databases different from car centric domain, learning of a classification method is performed by using not only car centric images but also non-car centric images. For example, by making use of existing image databases different from car centric domain, a fully convolutional neural network (FCN) for road segmentation is trained. In the present embodiment, a car centric image is, for example, an image taken by a camera fixed to a car, and it indicates an image of a road in a front direction when seen from an inside of a car, as a typical example.

Hereinafter, ImageNet (O. Russakovsky, et. al., “Image Net Large Scale Visual Recognition Challenge,” IJCV, 115, pp. 211-252, 2015), Places (B. Zhou, et. al., “Places: A 10 million Image Database for Scene Recognition,” PAMI, 2017), and Cityscapes (M. Cordts, et. al., “The city scapes dataset for semantic urban scene understanding,” In CVPR, 2016) are used as datasets.

From the above-described ImageNet and Places datasets, images labeled as roads are extracted and used for training. These images include not only car centric images but also non-car centric road images such as aerial views.

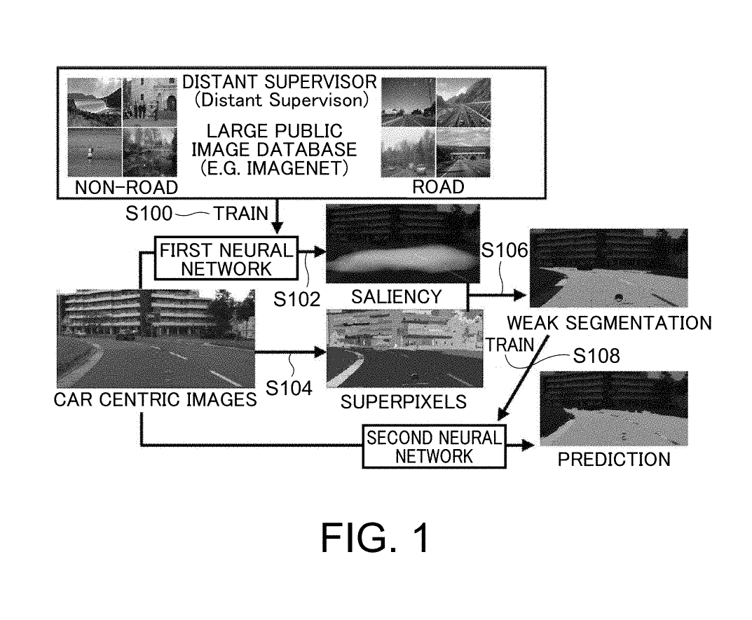

FIG. 1 is a view illustrating a concept of a broad overview of a classification method according to the present embodiment.

By using labeled non-road images and labeled road images, a training of a CNN which outputs a saliency map when a car centric road image is input, is performed (S100). The road images used for the training are not limited to car centric road images, and include non-car centric road images. For these pieces of data, pieces of data of the above-described ImageNet and Places are used, for example. In this case, data of Cityscapes is not used for the training and may be used as data for test. By using such datasets, it is possible to omit the labeling of data.

Next, a saliency map of the input car centric road image is generated (S102). The generation of the saliency map is performed by using the CNN obtained in S100.

In parallel with the generation of the saliency map, an image which represents the car centric road image by superpixels is generated (S104). Here, the superpixels indicate a region made of one or a plurality of pixels. For example, pixels which have similar features and which continuously exist in an image region are set as the same superpixels. It becomes possible to perform processing such as classification in the superpixel-wise manner.

Next, by using the generated saliency map and the image represented by the superpixels, a segmentation mask (weak segmentation) is generated (S106). In this step, by performing classification on a blurred saliency map by using superpixels, a sharper weak segmentation is generated.

Next, by using the generated weak segmentation image as supervised data, an FCN which outputs, when the car centric road image being an original image for generating the weak segmentation image is input, a predicted image in which a road region is segmented, is trained as a region classifier (S108). When a car centric image is input in the trained FCN (region classifier), an image capable of classifying the road region is output.

As described above, in the present embodiment, the two-stage training is performed on the CNN that outputs the saliency map (referred to as a first network, hereinafter) and the FCN that outputs the final classified image (referred to as a second network, hereinafter), to thereby train the second network that predicts the segmentation of the road region.

Hereinafter, the above-described respective steps will be described in more detail.

First, as pre-processing of the entire processing, images are collected. As described above, road images and non-road images are extracted from the databases. In images taken by a camera mounted in an ego-vehicle, there exist visible roads, so that images in which these roads are not photographed are required. However, the ego-vehicle images cannot be used for representing the road class. Because the images are quite homogenous, non-road objects such as a car body become salient if a classifier is trained. For this reason, non-homogenous road images are collected as well. Instead of collecting and annotating images, a distant supervision approach is used to collect images by taking advantage of large publicly available image databases described above.

For example, a label of road or highway is searched, to thereby collect images. Further, from images as a result of filtering out images extracted based on a label of indoor, images of road are further filtered out, to thereby collect non-road images. Note that regarding the collection of these images, the classification method according to the present embodiment can be applied as long as car centric road images, non-car centric road images, and non-road images are properly collected.

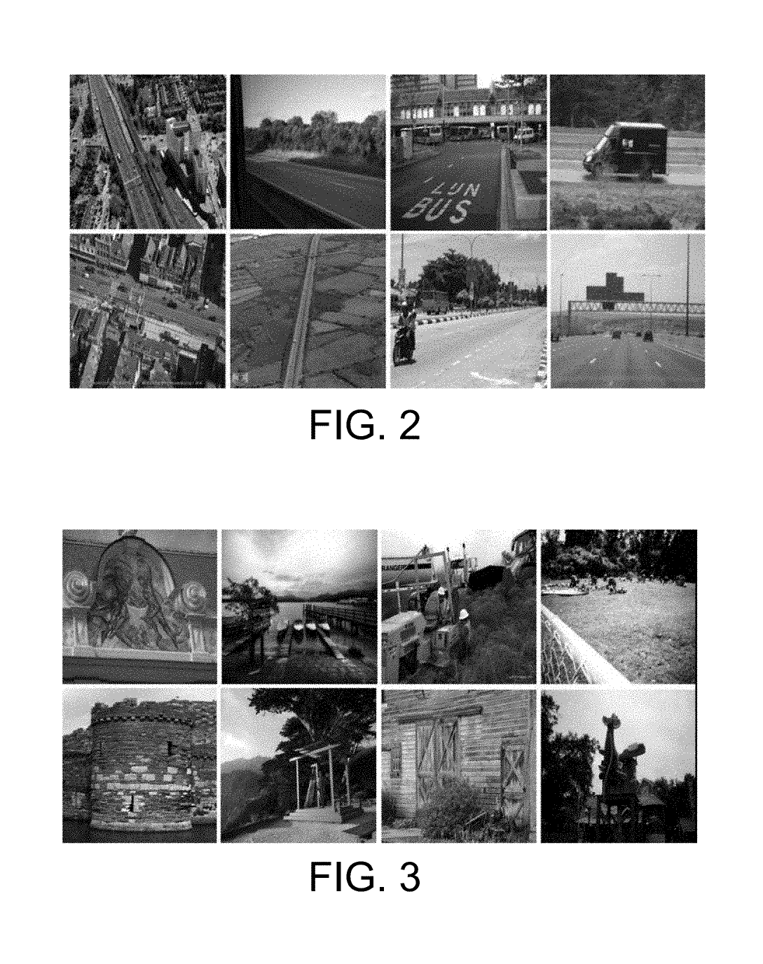

FIG. 2 are views illustrating examples of road images collected as above. The road images include car centric road images and road images such as ones taken from the sky.

Meanwhile, FIG. 3 are views illustrating examples of collected non-road images. For example, they are configured by images as a result of filtering out the indoor images and in which non-road objects are photographed, as described above.

Next, the first network is trained by using the collected images (S100). For example, as a simple architecture for obtaining a saliency map, a CNN which performs weighting with global average pooling (GAP: F. Yu, et. al., “Dilated residual networks,” arXiv preprint arXiv: 1705.09914, 2017) is utilized. It is set that fₖ (x, y) denotes the activation of channel k in the spatial position (x, y) in the last feature map of the CNN. Accordingly, the score S_{c} for class c is defined as follows.

$${S}_{c} = \frac{1}{N} {\sum }_{k} {w}_{k}^{c} \underbrace{{\sum }_{x , y}^{ } {f}_{k} ( x , y )}_{{F}^{k}} = \frac{1}{N} {\sum }_{x , y}^{ } \underbrace{{\sum }_{k}^{ } {w}_{k}^{c} {f}_{k} ( x , y )}_{{M}_{c} ( x , y )}$$

Here, N is the number of spatial positions (number of elements in layers), F^{k} is the value of GAP (the total sum of respective channels), and the class-specific weights wₖ′ are learned during training. The term M_{c} (x, y) can be interpreted as the saliency for class c at the spatial position (x, y). The training is performed through a general CNN training method using the GAP as a pooling method. Further, the pooling method is not limited to this, and another general pooling method may also be used. The number of layers and the like of the CNN, the hyper parameters, and so on can be appropriately and properly set.

As described above, by performing the training with the use of the images including roads (car centric images and non-car centric images) and the images which do not include roads, when an image is input, a saliency map such as one exhibiting saliency of a road region is output. As the supervised data, it is required to perform image-level labeling. Specifically, the CNN which outputs the saliency map is generated through the training which does not require a region-wise or pixel-wise annotation and labeling as indicating a road region with respect to each image.

By performing the training by using labeled images including roads and labeled images which do not include roads, there is formed a network that extracts features of roads which can be obtained in common among the images including the roads. By mapping the degree of being a road region as saliency in the process of extracting the features of the roads, it becomes possible to output a saliency map of the road region when an input image is input.

By using the first network trained as above, the saliency map with respect to the input image is generated (S102). The saliency map can be obtained by inputting the input image in the first network.

Before or after the generation of the saliency map, or in parallel with the generation of the saliency map, superpixels of the input image are generated (S104). For generating the superpixels, for example, a graph-based algorithm (P. F. Felzenszwalb et. al., “Efficient graph-based image segmentation,” IJCV, 59(2), pp. 167-181, 2004) is used. The method is not limited to this algorithm, and any method can be used as long as it is a method capable of properly generating superpixels.

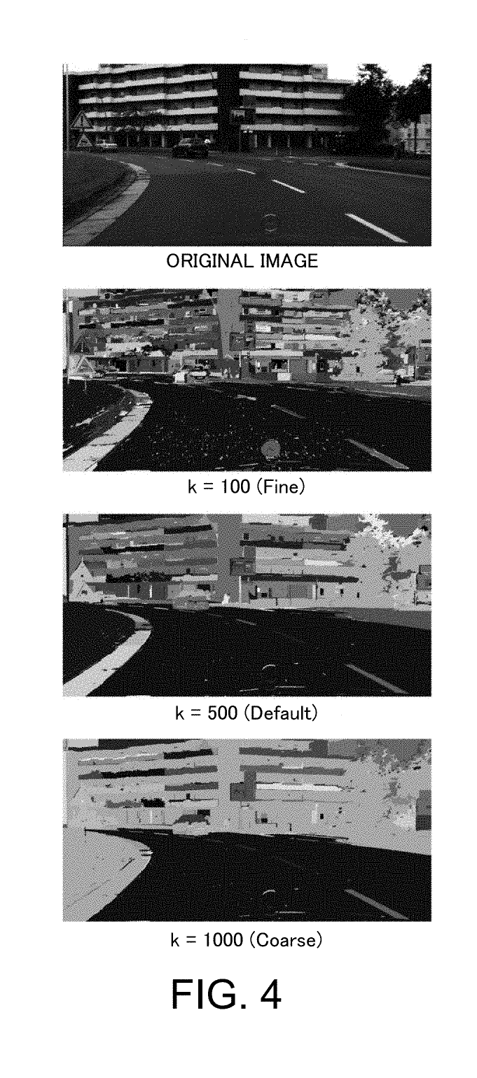

FIG. 4 are views illustrating examples of superpixels. The above-described superpixel generation algorithm has a threshold k being a parameter indicating the coarseness of the segmentation. When k is small, the segmentation is performed finely, and when k is large, the segmentation is performed coarsely. For example, when k=100, an image is segmented into finer regions when compared to a case where k=1000, and thus it is possible to perform fine classification.

Next, a weak road segmentation mask is generated based on the saliency map and the superpixels (S106). The superpixels are adopted on the assumption that the saliency map is blurred and not sharp enough to be regarded as an accurate segmentation. Besides, the superpixels are adopted to the saliency map on the assumption that a large superpixel can cover the road because it tends to have similar appearance (for example, color and texture) within an image.

P_{τ}={(x, y): M (x, y)>τ} denotes a salient area given by a saliency threshold τ. When a set of superpixels S are given, a weak label y_{weak}⁽ⁱ⁾ at location i is obtained as follows.

$${y}_{weak}^{( i )} = \{ \begin{matrix}road & \vert {s}_{i} ⋂ {P}_{τ} \vert / \vert {P}_{τ} \vert > θ \\ other & otherwise\end{matrix} , ∀ {s}_{i} ∈ S$$

Here, θ is an overlap threshold. That is, for each superpixel, if the overlap with the salient area is greater than θ, the superpixel is regarded as corresponding to a road region.

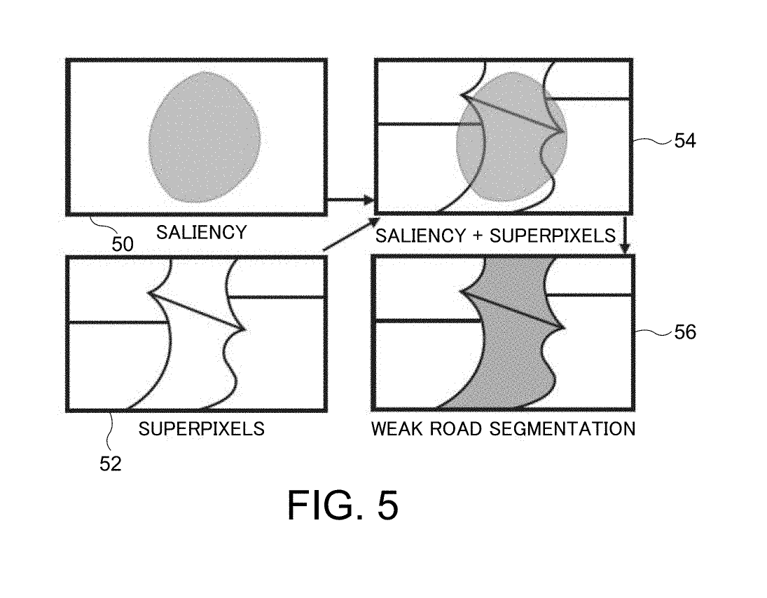

FIG. 5 is a view illustrating the generation of the weak road segmentation mask described above.

The saliency map is shown in the top-left side (50), and the superpixels are shown in the bottom-left side (52) of the view. The saliency map is classified by the saliency threshold τ, and a salient area is represented as a portion indicated by gray in the view, for example.

These images are overlapped, as shown in the top-right side (54) of the view. When, as a result of overlapping the images, the overlap with the salient area in the superpixel satisfies [mathematical expression 2], the superpixel is judged as a weak label.

The bottom-right view (56) shows the superpixels judged as the weak labels. In a manner as described above, [mathematical expression 2] is applied to each of all superpixels to extract weak labels, and the weak labels are combined to obtain a weak segmentation.

Next, the second network is trained (S108). The weak segmentation generated in S106 is data as a result of eliminating noise and the like and thus which is better than the original training data, and by training the FCN by using the image generated as above, the second network is generated. As the FCN, for example, SegNet (V. Badrinarayanan, et. al., “SegNet: A Deep Convolutional Encoder-Decoder Architecture for Image Segmentation,” PAMI, 2017) may be used, but, since the present method does not depend on SegNet, another FCN may also be used.

It is also possible to generate a region classifier with higher precision by using an output image of the generated second network. For example, a region classification result output by the second network is set to supervised data, and a third network which outputs, when an image is input, the region classification result output by the second network is generated through training. This training can also be performed successively, and an Nth network which outputs an output result of a trained N−1th network in which N is set to a natural number of 3 or more, may also be generated through training as a region classifier.

Hereinafter, experimental results will be shown, and besides, effects of a classification apparatus according to the present embodiment will be described. In the experiments to be described below, images from ImageNet and Places were used as training data, and images from CityScapes were used as images to confirm the results.

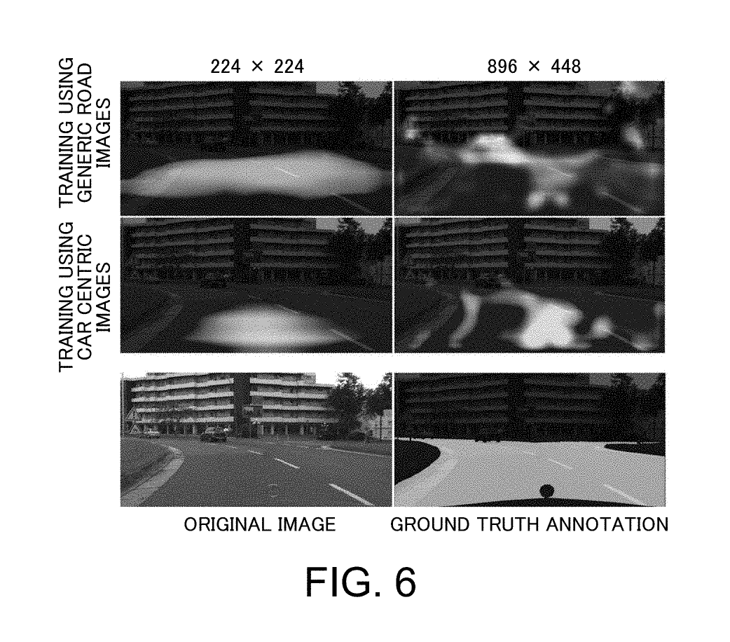

FIG. 6 are views illustrating output examples of the learned first network. The bottom row shows an input image and a ground truth image. It can be said that as an output image is closer to the ground truth image, the better precision is provided. The first row shows outputs of the first network trained by using general road images, namely, images which are not limited to car centric images as road images, and the second row shows outputs of the first network trained by using, not the images from ImageNet and Places, but only car centric images included in CityScapes. In the first row and the second row, a left column shows results of training by using images with low resolution, and a right column shows results of training by using images with high resolution.

In FIG. 6, regarding the image with low resolution, the training is performed using the resolution of 224×224 pixels to obtain a 14×14 saliency map, and regarding the image with high resolution, the training is performed using the resolution of 896×448 pixels to obtain a 56×28 saliency map. For example, the result images shown in FIG. 6 are obtained when the input image is reduced to the above-described resolutions to generate the saliency maps and then magnified. The reduction or the magnification is performed by bilinear interpolation, for example. In FIG. 6, a saliency threshold τ was set to 0.75. The car centric image used an image in Cityscapes, for example.

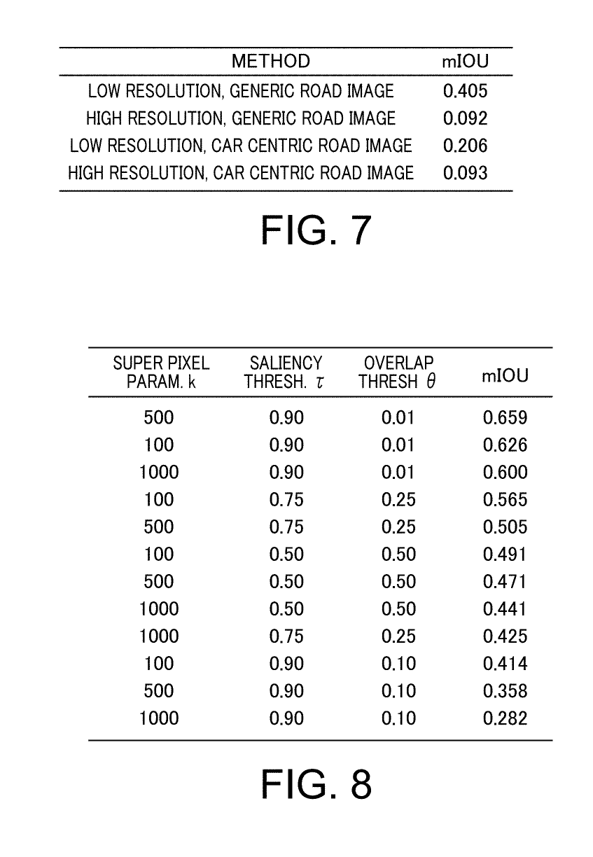

As an index for evaluation, an mIOU (Mean Intersection-Over-Union) was used. FIG. 7 is a table representing an mIOU in each view in FIG. 6 with respect to the ground truth image. As shown in FIG. 7, it can be understood that the mIOU using the general road image with low resolution is the highest. It can be understood that the low resolution yields better precision in both of the general image and the car centric image.

One of reasons to bring about this result is that a feature of another region which is not a road is reflected on the saliency map when the image has high resolution. For example, regarding the result of using the general image with high resolution in FIG. 6, since the saliency is recognized in the car, a region of the car in the input image is reflected on the saliency map. Further, in this case, the traffic sign is also reflected on the saliency map. Meanwhile, regarding the result of using the car centric image with high resolution, the saliency is recognized in the car body and the emblem of the own car, and thus regions of these are reflected on the saliency map.

When the image has high resolution, there is a case where the saliency is recognized in, not a road in a broad sense, but objects that exist in the periphery of the road, and the objects are reflected on the saliency map. This problem can be avoided by using images with low resolution for training, input, and the like.

Further, in FIG. 7, the mIOU using the general image is 0.405, but, the mIOU using the car centric image is 0.206. Based on this, it is possible to realize improvement of precision by using not only car centric images but also general images, for example, aerial views in which roads are photographed, and the like.

FIG. 8 is a table representing results of generating road segmentation masks (weak segmentations) each combining a saliency map and superpixels. As described above, there exist three parameters, namely, the superpixel threshold k, the saliency threshold τ, and the overlap threshold θ. From this table, it can be understood that when k is set to a proper value, and then τ is increased and θ is reduced, a good result is obtained. As described above, using a high saliency threshold and a low overlap threshold gives a good result.

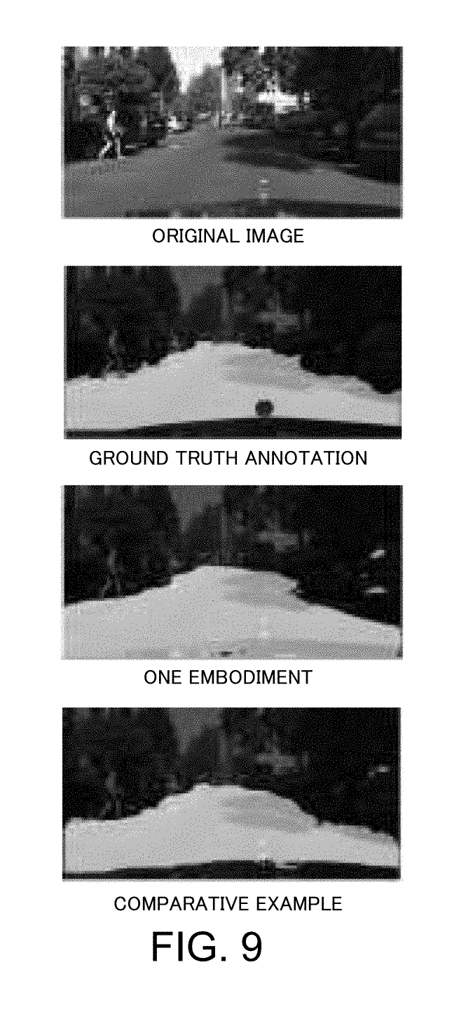

FIG. 9 are views showing an image output by the second network according to the present embodiment, namely, an image as a result of segmenting a road region. The top view is an input image, the second view is a ground truth image, the third view is an image output by the method according to the present embodiment, and the fourth view is an output image output by the FCN trained by using the ground truth image.

From these images, it can be quantitatively understood that the second network trained by using the weak segmentation can output a high-precision image. Hereinafter, mIOUs will be concretely shown in a quantitative manner.

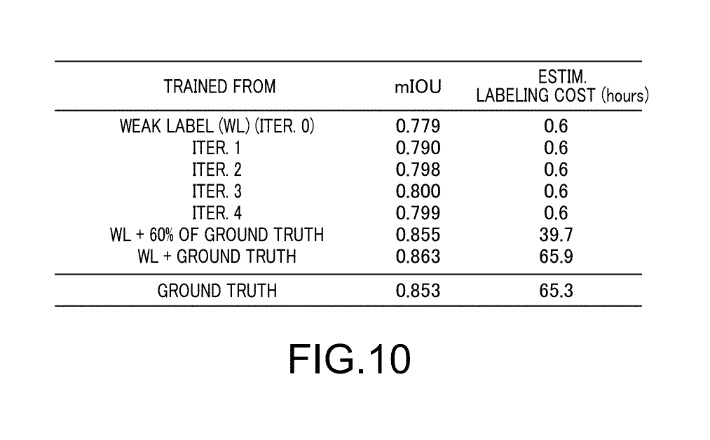

FIG. 10 is a table representing mIOUs of ground truth images and respective regions obtained through various kinds of simulations and judged as road regions and approximate time taken for labeling. The bottom row shows an example, as a comparative example, in which a user generates the ground truth images and sets the images as supervised data for the FCN. In this case, the mIOU of the ground truth images and the segmentation output by the FCN is 0.853.

A result of the first row shows a result of training the second network by using the weak segmentation masks. As indicated by this result, when the weak segmentation masks are used, a value of mIOU which used to be 0.659 is improved to 0.779 being a value higher than that. Further, even if compared with the FCN trained by using the ground truth images, a high precision of 91.3% is provided. As described above, this indicates that training the second network from weak and noisy labels is effective for removing the outliers and/or noise, and that the FCN is able to learn the common ingredients of the noisy segmentation masks, which should be closer to the ground truth images.

In order to generate the ground truth images, it is required to perform pixel-wise labeling, and a cost for this labeling becomes high as indicated in FIG. 9. On the other hand, the image-level labeling is to select labels from databases in particular as in the present embodiment, which does not require a high cost.

A result of the second row indicates a result output by a third network being an FCN trained with a segmentation output by the second network as supervised data. It can be understood that the mIOU is improved from 0.779 to 0.790.

The same applies to the third row to the fifth row. In the order from the top, mIOUs regarding an output of a fourth network trained with the output of the third network, an output of a fifth network trained with the output of the fourth network, and an output of a sixth network trained with the output of the fifth network are respectively shown. As shown in this view, it becomes possible to obtain, through training, a network such as one achieving the mIOU of 0.8.

Other than the method of realizing the improvement of precision by successively generating the networks as described above, there is also a method in which the weak segmentations and the ground truth images are mixed to generate training data, thereby making the FCN perform learning.

Each of the sixth row and the seventh row in FIG. 9 indicates that the weak segmentations and the ground truth images are mixed to generate a network. For example, the second network is trained with the weak segmentations, and then the network is fine-tuned by using the ground truth images. The sixth row indicates a result of performing tuning by using the ground truth images whose number is 60% of the number of the ground truth images of the bottom row, and by such a mixing, there is provided an mIOU which is almost the same as that obtained by performing training by using the ground truth images. On the other hand, the time for performing labeling can be reduced to about 60% of that for the ground truth images. It is also possible that the above-described methods are combined, and that the Nth network is tuned with the ground truth images.

As described above, according to the present embodiment, it becomes possible to generate the segmentation of a road region that only requires image-level annotations at training time. By performing the distantly supervision, it is possible to generate a segmentation mask that does not require pixel-wise annotations. When the segmentation mask is generated as above, and learning is performed so as to extract and classify a road region by utilizing the segmentation mask, it becomes possible to perform extraction of the region and classification of the region in which the road region is set to a target region. As a result of this, it becomes possible to extract and classify the target region with high precision without generating ground truth images regarding all images used for training, namely, while reducing a cost taken for the annotation.

Although the training is performed by using the road images and the non-road images, by using the car centric images and non-car centric images as the road images, it is possible to reduce the training time and improve the precision of the region extraction and the region classification. Specifically, when the FCNs (the second network, . . . , and the Nth network) that extract and classify the target region from the input image including the target region are generated as the region classifiers, by using the images each including the target region and taken from the perspective view same as that of the input image and the images each including the target region and taken from the perspective view different from that of the input image, it is possible to realize the reduction of the training time and the improvement of precision.

Note that regarding the part described as image in the above description, the image is not required to be input or output as an actual image, and it may be data indicating the image. For example, the respective pieces of data to be input may be subjected to compression, encoding, or the like by various kinds of formats (formats of JPEG, PNG, and the like), or may also be raw data. Further, the images used for classification such as the weak segmentation images and the predicted images may be ones which are input or output as pixel-wise labeled data, or data regarding regions classified as roads, for example, data including only coordinates of pixels and the like, but, they are not limited to these, and may also be data such as one encoded as an actual image.

Further, although the embodiment is designed to classify the road images, it is not limited to this, and it can be applied to the other various images. For example, the embodiment can be applied to a case where a robot operates based on an image taken by using a camera fixed to the robot, and the like.

The embodiment can also be applied to a case where networks that classify a required target region are generated by performing the distantly supervision on the images taken from perspective views different from own perspective view to generate the weak segmentations as described above. Specifically, when the target region classification is performed, it is possible to generate the weak segmentation by using the images having the perspective views same as and different from the perspective view of the input image which is subjected to the region classification as the training data, and by using this weak segmentation, it is possible to train the second network that classifies the target region.

When the perspective views are the same, this does not necessarily mean that the perspective views are strictly the same, and this may mean that the perspective views are equivalent. For example, if an on-vehicle camera is used, the camera may be placed on a rear side of a rearview mirror, or it may also be placed on a lower side of a front glass.

Although the first network has been described as the CNN, and the second network, . . . , and the Nth network have been described as FCNs, they are not limited to these, and each of the networks can also use a neural network model which is proper for classifying images.

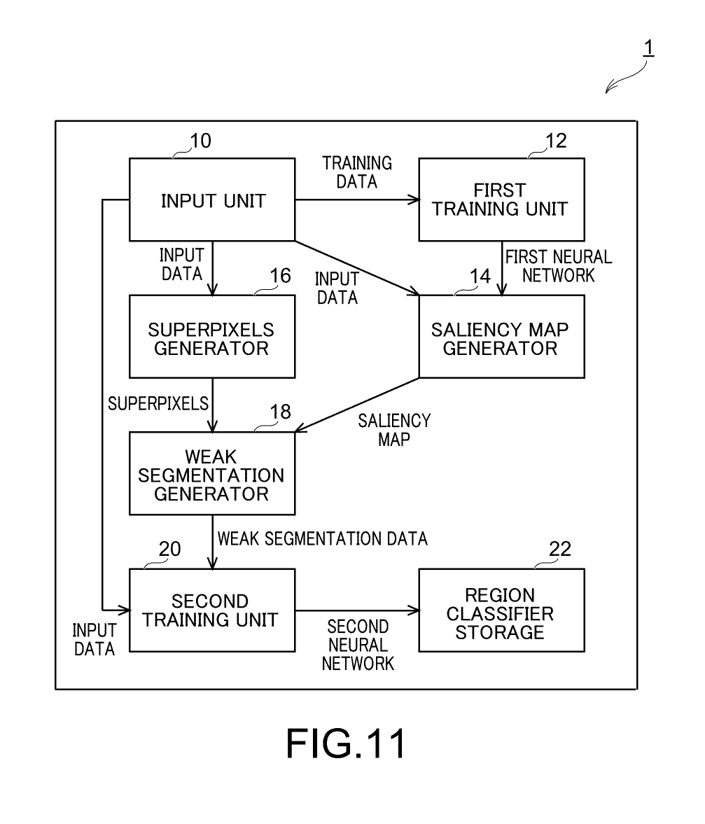

Hereinafter, a configuration example regarding the above-described embodiment will be described. FIG. 11 is a view illustrating a configuration of an apparatus for carrying out the method of the present embodiment.

As illustrated in FIG. 11, a region classifier training apparatus 1 includes an input unit 10, a first training unit 12 (a first trainer), a saliency map generator 14, a superpixel generator 16, a weak segmentation generator 18, a second training unit 20 (a second trainer), and a region classifier storage 22.

The input unit 10 accepts inputs of various kinds of pieces of data used for training. The input may be successively performed, or a not-illustrated data storage may be included in the region classifier training apparatus 1, and the data which is used for training may be previously input in the data storage via the input unit to be stored.

The first training unit 12 trains the first network which outputs the saliency map. For the training data, the non-road images, the car centric road images, and the non-car centric road images are used, as described above. The first training unit 12 outputs the first network after being subjected to the training to the saliency map generator 14. Note that the output may also be output to the not-illustrated storage.

The saliency map generator 14 outputs the saliency map by inputting the input image being the car centric road image to the first network trained and generated by the first training unit 12.

Based on the input image, the superpixel generator 16 outputs superpixels of the input image.

The weak segmentation generator 18 generates the weak segmentation based on the saliency map generated by the saliency map generator 14 and the superpixels generated by the superpixel generator 16.

The second training unit 20 generates the second network that extracts and classifies the road region when the input image is input, through training by using the weak segmentation output by the weak segmentation generator 18 as supervised data.

The region classifier storage 22 stores the second network trained and generated by the second training unit 20 as the region classifier. When the Nth network is generated, the second training unit 20 uses the N−1th network stored in the region classifier storage 22 to generate data in which the region is extracted and classified, and trains the Nth network by using the generated data as supervised data.

Note that it is also possible that the second training unit 20 does not make the region classifier storage 22 store the generated second network, and it outputs the second network to the outside of the region classifier training apparatus 1 via a not-illustrated output unit.

The region classifier itself stored in the region classifier storage 22 or the region classifier itself output by the second training unit 20 can also be used as a region classification apparatus, and the region classifier training apparatus 1 may also serve as a region classification apparatus that classifies the region by using the region classifier stored in the region classifier storage 22.

In the region classifier training apparatus 1 and the region classification apparatus in the above-described embodiment, the respective functions may also be circuits configured by analog circuits, digital circuits, or analog digital mixing circuits. Further, a control circuit that controls the respective functions may also be provided. The mounting of the respective circuits may also be realized through application specific integrated circuit (ASIC), field programmable gate array (FPGA), or the like.

In the above entire description, at least a part of the region classifier training apparatus 1 and the region classification apparatus may be configured by hardware, or may also be configured by software and a CPU and the like perform the operation based on information processing of the software. When it is configured by the software, it is possible to design such that a program which realizes the region classifier training apparatus 1, the region classification apparatus, and at least a partial function thereof is stored in a storage medium such as a flexible disk or a CD-ROM, and read by a computer to be executed. The storage medium is not limited to a detachable one such as a magnetic disk or an optical disk, and it may also be a fixed-type storage medium such as a hard disk device or a memory. Specifically, it is possible to design such that the information processing by the software is concretely implemented by using a hardware resource. Besides, it is also possible to design such that the processing by the software is implemented by the circuit of FPGA or the like and executed by the hardware. The generation of the model or processing after performing input in the model may be carried out by using an accelerator such as a GPU, for example.

For example, when a computer reads dedicated software stored in a storage medium capable of being read by the computer, it is possible to make the computer function as the apparatus of the above-described embodiment. A type of the storage medium is not particularly limited. Further, when a computer installs dedicated software downloaded via a communication network, it is possible to make the computer function as the apparatus of the above-described embodiment. In a manner as described above, the information processing by the software is concretely implemented by using the hardware resource.

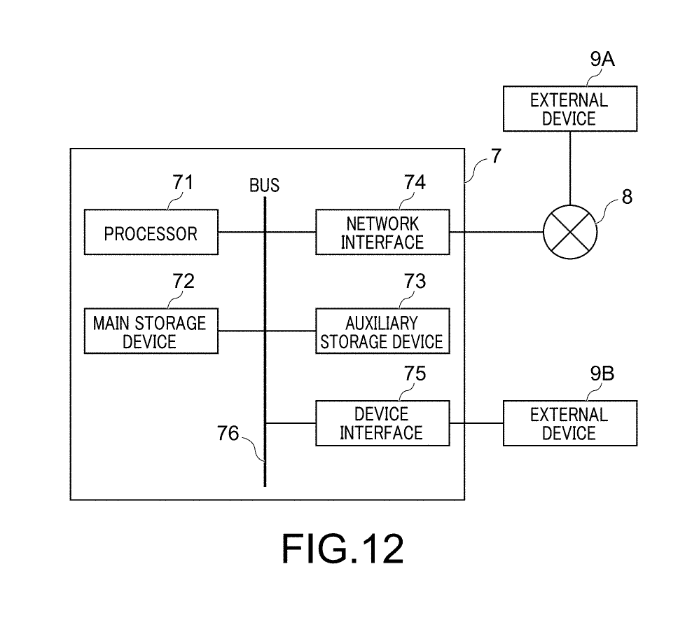

FIG. 12 is a block diagram illustrating an example of a hardware configuration according to an embodiment. Each trainer or classifier can be implemented as a computer 7 including a processor 71, a main storage device 72, an auxiliary storage device 73, a network interface 74, and a device interface 75, which are connected together via a bus 76. In addition, each device or module may further include an input device and an output device.

Each device, module or apparatus such as one of the trainers or classifiers according to the present embodiment may be implemented by installing in advance a program executed in each device in the computer 7, or by storing the program in a storage medium such as a CD-ROM, or distributing the program via a network, and installing the program in the compute 7 as appropriate.

The computer 7 includes each one of the constituents; however, the computer 7 may have a plurality of the same constituents. In addition, one computer is illustrated; however, software may be installed in a plurality of the computers. Each of the plurality of computers may execute processing of a different part of the software to generate a processing result. That is, the data processing device may be configured as a system.

The processor 71 is an electronic circuit (circuitry) including a control device and a computing device of a computer. The processor 71 performs arithmetic processing on the basis of data and programs input from each device or the like of the internal configuration of the computer 7, and outputs calculation results and control signals to each device or the like. Specifically, the processor 71 executes an operating system (OS) of the computer 7, an application, and the like, and controls devices configuring the computer 7.

The processor 71 is not particularly limited to this as far as the processing described above can be performed. The processor 71 may be, for example, a general purpose processor, a central processing unit (CPU), a microprocessor, a digital signal processor (DSP), a controller, a microcontroller, a state machine, or the like. In addition, the processor 71 may be incorporated in an application specific integrated circuit (ASIC), a field-programmable gate array (FPGA), or a programmable logic device (PLD). In addition, the processor 71 may be configured from a plurality of processing devices. For example, the processor 71 may be a combination of the DSP and the microprocessor, or may be one or more microprocessors working with a DSP core.

The main storage device 72 is a storage device that stores instructions executed by the processor 71, various data, and the like, and information stored in the main storage device 72 is directly read by the processor 71. The auxiliary storage device 73 is a storage device other than the main storage device 72. The storage device is intended to mean any electronic component capable of storing electronic information. Volatile memory used for temporary storage of information such as random access memory (RAM), dynamic RAM (DRAM), or static RAM (SRAM) is mainly used as the main storage device 72; however, in the embodiment of the present invention, the main storage device 72 is not limited to these volatile memories. The storage device used as the main storage device 72 and the auxiliary storage device 73 each may be a volatile memory or a nonvolatile memory. The nonvolatile memory is programmable read only memory (PROM), erasable PROM (EPROM), non-volatile RAM (NVRAM), magnetoresistive RAM (MRAM), flash memory, or the like. As the auxiliary storage device 73, magnetic or optical data storage may be used. As the data storage, a magnetic disk such as a hard disk, an optical disk such as a DVD, a flash memory such as a USB memory, a magnetic tape, or the like may be used.

If the processor 71 reads or writes information directly or indirectly to the main storage device 72 or the auxiliary storage device 73, or both, it can be said that the storage device communicates electrically with the processor. The main storage device 72 may be integrated in the processor. Also in this case, it can be said that the main storage device 72 communicates electrically with the processor.

The network interface 74 is an interface for connecting to a communication network by wireless or wire. As for the network interface 74, one conforming to the existing communication standard can be used. An output result or the like may be transmitted to an external device 9A communicably connected via a communication network 8 by the network interface 74, or may be transmitted to an external device 9B directly via the device interface 75.

The device interface 75 is an interface such as USB connected to the external device 9B that records the output result and the like. The external device 9B may be an external storage medium or storage such as a database. The external storage medium may be any arbitrary storage medium such as a HDD, CD-R, CD-RW, DVD-RAM, DVD-R, storage area network (SAN) and the like. Alternatively, the external device 9A, 9B may be an output device. The output device is, for example, a liquid crystal display (LCD), a cathode ray tube (CRT), a plasma display panel (PDP), a speaker, or the like, but it is not limited thereto.

Part or all of the computer 7, that is, part or all of the data processing device may be configured by a dedicated electronic circuit (hardware) such as a semiconductor integrated circuit on which the processor 71 and the like are mounted. The dedicated hardware may be configured in combination with the storage device such as the RAM, ROM, and the like.

In FIG. 12, one computer is illustrated; however, software may be installed in a plurality of the computers. Each of the plurality of computers may execute processing of a different part of the software to generate a processing result.

In the description above, each device, module or apparatus according to above mentioned embodiments can be implemented as a computer in FIG. 12, it is not limited to this condition. For example, a training system or a classifier is configured like the computer 7 illustrated in FIG. 12, each trainer or classifier is configured by a software described by a program stored in the auxiliary storage device 73, and information processing by the software may be specifically realized by using hardware resources.

A person skilled in the art may come up with addition, effects, or various kinds of modifications of the present invention based on the above-described entire description, but, examples of the present invention are not limited to the above-described individual embodiments. Various kinds of addition, changes and partial deletion can be made within a range that does not depart from the conceptual idea and the gist of the present invention derived from the contents stipulated in claims and equivalents thereof. For example, in all of the embodiments described above, the numeric values used for the explanation are indicated as examples, and the numeric values are not limited to these.

The model generated by the region classifier training apparatus 1 according to the present embodiment can be used as a program module being a part of artificial-intelligence software. Specifically, a CPU, a GPU, or the like of a computer operates to perform calculation and output results based on the model stored in a storage.

Various kinds of calculation for learning and inference may be carried out through parallel processing by using an accelerator such as a GPU or by using a plurality of calculating machines via a network. For example, batch processing in the learning, and processing such as generation of operation information of each object in the inference may be executed at the same timing by dividing the calculation among a plurality of arithmetic cores.

1. A region classifier training method comprises:
generating a first network which outputs a saliency map with respect to an input image;
generating superpixels of the input image;
generating a weak segmentation for extracting a target region based on the saliency map and the superpixels; and
training and generating a second network being a region classifier which classifies the target region when the input image is input, by using the weak segmentation as supervised data.

2. The region classifier training method according to claim 1, wherein
the generating the first network performs training by using images each including the target region and having a perspective view equivalent to that of the input image, images each including the target region and having a perspective view different from that of the input image, and images which do not include the target region.

3. The region classifier training method according to claim 1, wherein
the generating the first network performs training by using image-level labeled images including the target region, and image-level labeled images which do not include the target region, without performing labeling of pixels of the target region in each of the images.

4. The region classifier training method according to claim 1, wherein
the generating the weak segmentation generates the weak segmentation by deciding which of the superpixels belongs to the target region based on:
the total number of pixels judged as the target region in the saliency map; and
the number of pixels existing in each of the superpixels and judged as the target region, when the saliency map and the superpixels are overlapped.

5. The region classifier training method according to claim 1, wherein
the generating the region classifier performs the training through supervised learning so that the weak segmentation is output when the input image is input.

6. The region classifier training method according to claim 1, wherein
the generating the region classifier further performs successive training on an Nth network in which N is set to a natural number of 3 or more, by using an image output by an N−1th network as supervised data, and generates the Nth network after performing the learning as the region classifier.

7. The region classifier training method according to claim 1, wherein
the generating the region classifier performs learning by using the weak segmentation and ground truth as supervised data.

8. A region classification apparatus comprises the region classifier generated by using the method according to claim 1.

9. A non-transitory computer readable medium recording a program which makes a computer function as the region classifier generated by using the method according to claim 1.

10. A training apparatus comprises:
a memory; and
a processing circuitry configured to:
generate a first network which outputs a saliency map with respect to an input image through training;
generate superpixels of the input image;
generate a weak segmentation for extracting a target region based on the saliency map and the superpixels; and
train and generate a second network being a region classifier which classifies the target region when the input image is input, by using the weak segmentation as supervised data.

11. A non-transitory computer readable medium recording a program which makes a computer execute as:
a first trainer generating a first network which outputs a saliency map with respect to an input image through training;
a superpixel generator generating superpixels of the input image;
a weak segmentation generator generating a weak segmentation for extracting a target region based on the saliency map and the superpixels; and
a second trainer training and generating a second network being a region classifier which classifies the target region when the input image is input, by using the weak segmentation as supervised data.
